(19) United States
(12) Patent Application Publication
(10) Pub. No.: US 2004/0247977 A1
(43) Pub. Date: Dec. 9, 2004

(54) Electrochemical cell and fuel cell with curable liquid electrolyte

(76) Inventors: Steven Holdcroft, Pitt Meadows (CA); Jianfei Yu, Burnaby (CA)

Correspondence Address: BUSKOP LAW GROUP, P.C., 1717 ST. JAMES PLACE, SUITE 500, HOUSTON, TX, 77056, US

(21) Appl. No.: 10/781,363

(22) Filed: Feb. 18, 2004

Related U.S. Application Data
(60) Provisional application No. 60/476,404, filed on Jun. 6, 2003.

(51) Int. Cl. H01M 8/10; C08J 5/22

(52) U.S. Cl. 429/33; 429/314; 429/317; 521/27

(57) ABSTRACT

The invention relates to a fuel cell and an electrochemical cell comprising a curable protonic polymer based electrolyte composition. The electrolyte composition comprises between 10 wt % and 50 wt % of a protonic polymer comprising acidic groups for transporting protons; between 10 wt % and 89 wt % of a monomer for dissolving the protonic polymer; between 1 wt % and 60 wt % of a cross linking agent having at least two vinyl functionalities; and wherein upon combining the protonic polymer, monomer and cross linking agent, a curable electrolyte solution is formed with at least 50 wt % of the above components based on the total weight percent of the formed solution. The invention relates to a method for producing the curable liquid electrolyte.

The present application claims priority to co-pending U.S. Provisional Patent Application Ser. No. 60/476,404 filed on Jun. 6, 2003.

### FIELD

The present invention relates to a curable liquid electrolyte for an electrochemical cell made of a protonic polymer, a cross linking agent, such as a vinyl monomer, and a protonic polymer.

### BACKGROUND

Polymer electrolyte membranes are useful in electrochemical devices such as batteries and fuel cells since they function as an electrolyte and also as a reactant separator. Typical membranes of this type are fabricated as thin films and then incorporated into cells and systems of various configurations.

Current known membranes, however, possess severe limitations which, in addition to their cost, detract from their utility in new and advanced fuel cell designs.

Known membranes possess compromising properties, for example, sulfonated polystyrenes rapidly, sulfonated polyaromatics often adversely swell in water and form poor interfaces with catalyst layers; PBI/phosphoric acid membranes do not operate below 120 degrees Celsius. It is hard to find a low cost alternative to these commercially known membranes because of the difficulties in finding suitable materials, synthetic methods, and the limited choice in base materials.

Known sulfonated polyaromatics also possess very high softening temperatures and degrade at these increased temperatures. Solid polymer electrolytes inherently possess very high softening temperatures by virtue of their high concentration of ions. Thus, membrane films to produce assemblies of membranes and catalyzed electrodes are difficult to process and result in limited manufacturing parameters, such as high pressure, high temperature compression techniques which are a far from satisfactory commercial solutions. Due to the lack of alternative materials and the high softening temperatures of ionic polymers, a need has existed for a new type of electrolyte for electrochemical cells. A need has particularly existed for a composition which can limit delamination of the membrane from the catalyst layer for electrode assemblies. Delaminating is due to poor chemical or physical bonding.

Traditionally, matching the chemical nature of the membrane with the catalyst layer has been difficult. The match is needed to form a chemical bond between the membrane and the catalyst layer. This failure mechanism is therefore a direct consequence of the manufacturing constraints imposed by the mechanical properties of the membrane material. The present invention has been designed to meet these needs.

A need exists within the design of electrochemical cells for polymer electrolyte membranes which become soft and pliable at lower temperatures and that can be brought into intimate contact with catalyzed electrodes of arbitrary three dimensional shape without the use of high temperature compression methods.

### SUMMARY

The invention relates to a fuel cell and electrochemical cell having a curable protonic polymer based electrolyte composition. The composition is for nanosized cells with preferably between 10 wt % and 50 wt % of a protonic polymer comprising acidic groups for transporting protons; between 10 wt % and 89 wt % of a monomer for dissolving the protonic polymer; and between 1 wt % and 60 wt % of a cross linking agent having at least two vinyl functionalities.

Upon combining the protonic polymer, monomer and cross linking agent, a curable electrolyte solution is formed with at least 50 wt % of the above components based on the total weight percent of the formed solution. Optionally, a quantity of initiator sufficient to cure the composition can be added to the composition, particularly if the electrolyte is to be cured using photo-curing or thermal curing.

The invention also relates to a method for producing a curable liquid electrolyte usable in nano-sized fuel cells and micro-structured electrochemical cells

### BRIEF DESCRIPTION OF THE DRAWINGS

The present invention will be explained in greater detail with reference to the appended figures, in which:

FIG. 1 schematically depicts an example of an electrochemical cell incorporating a membrane of the proton exchange membrane.

FIG. 2 schematically depicts an example of a fuel cell of novel architecture requiring the use of non-conventional electrolytes. I

FIG. 3 depicts sulfonation level as a function of heating time for curable electrolyte mixtures based on sulfonated PEEK.

FIG. 4 includes a graph indicating the relationship between time and sulfonation level of PEEK.

FIG. 5 includes a table of proton conductivity values for cured liquid electrolytes.

FIG. 6 includes a table of conductivity and water uptake values for liquid electrolytes with different sulfonation levels.

The present invention is detailed below with reference to the listed Figures.

### DETAILED DESCRIPTION OF THE PREFERRED EMBODIMENTS

Before explaining the present invention in detail, it is to be understood that the invention is not limited to the particular embodiments and that it can be practiced or carried out in various ways.

The invention relates to fuel cells and other electrochemical cells using a curable protonic polymer based electrolyte composition. The invention is particularly usable for nano-sized fuel cells that need very small particle sizes in the electrolyte. The composition has between 10 wt % and 50 wt % of a protonic polymer. The protonic polymer has acidic groups for transporting protons. The composition also has between 10 wt % and 89 wt % of a monomer for dissolving the protonic polymer and between 1 wt % and 60 wt % of a cross linking agent having at least two vinyl functionalities.

Upon combining the protonic polymer, monomer, and cross linking agent, a curable electrolyte solution is formed with at least 50 wt % of the above components based on the total weight percent of the formed solution. The electrolyte is then usable between the oxidant and fuel plenums. The electrolyte is usable between the anode and the cathode of a fuel cell.

The composition can further include a quantity of initiator sufficient to cure the composition when using a procedure, such as photo-curing, thermal curing or such combinations. The initiator unexpectedly will facilitate curing without affecting catalyst used with the anodes or cathodes of the fuel cell. The faster curing time lowers the cost to make these types of nano-sized fuel cells.

A preferred composition contains between 20 wt % and 40 wt % of a protonic polymer comprising acidic groups for transporting protons, between 20 wt % and 70 wt % of a monomer for dissolving the protonic polymer, and between 5 wt % and 50 wt % of a cross linking agent having at least two vinyl functionalities. If an initiator is used, the composition includes between 5 wt % and 10 wt % of the initiator.

In an alterative embodiment, the electrolyte has between 10 wt % and 50 wt % of a protonic polymer. The protonic polymer has acidic groups for transporting protons. The composition uses between 10 wt % and 89 wt % of a polar monomer and a polar solvent for dissolving the polar monomer. Between 1 wt % and 60 wt % of a cross linking agent having at least two vinyl ftnctionalities is also used. The polar solvent is either water or an organic fluid. Some examples of usable polar solvents include dimethylformamide, dimethylacetamide, n-methylpyrrolidinone, similar compounds, and combinations thereof.

When the protonic polymer, polar monomer, polar solvent, and cross linking agent are mixed into a formulation, a curable electrolyte solution is formed with at least 50 wt % of the above components based on the total weight percent of the formed solution.

The polar monomer is preferably a vinyl monomer bearing an acidic group, such as a sulfonic acid group, a phosphonic acid group, a carboxylic acid group, or combinations thereof.

The cross-linking agent preferably is a divinyl derivative of an organic compound. The organic compound can be an aliphatic, an aromatic, a heteroaromatic, or combinations thereof. The organic compound can also be sulfonic acid, a sulfone, a phosphate, a phosphone, a phosphonic acid, a carboxylate, a carboxylic acid, an acrylate, a methylacrylate, an acrylamide, a methacrylamides, or combinations thereof.

The cross linking agent preferably is a trivinyl derivative of an organic compound. The organic compound for the cross-linking agent can be sulfonic acid, a sulfone, a phosphate, a phosphone, a phosphonic acid, a carboxylate, a carboxylic acid, an acrylate, a methylacrylate, an acrylamide, a methacrylamides, or combinations thereof.

The invention also contemplates that the curable liquid electrolyte solution can further comprise an elastising agent. The elasticizing agent can be a polymerizable vinyl monomer to enhance the toughness of structure of the cured electrolyte.

Micro and nano structured materials refer to materials which have feature sizes that are measured in microns or smaller. The feature sizes can be a benefit of the material structure itself, as is the case of materials which are porous with very small pore sizes. Alternatively the features can be formed into the material to create a patterned microstructure.

Micro-structured materials have many practical applications including filtration, production of electronic components, micro-sensors, fuel processing, and electrochemical cells.

Non-porous materials, into which micro-structures are commonly formed, can be a silicon wafer, an alumina, various ceramics, metals and plastics. These materials are processed using methods, such as laser ablation, wet etching, deep reactive ion etching, electro-discharge machining, dicing, water jet cutting, micro-injection molding, casting or molding.

Porous media with defined micro-structures typically have pore sizes ranging from less than 1 nm to 10 microns, more preferably between 20 nm and 100 nm. Porous media with micro-pores can be an aero-gel, a foam, or a mat or felt of conductive and non-conductive materials. The porous media can be porous plastics and ceramics.

In electrochemical cell applications, including fuel cells, it is desirable to combine the micro-structured porous material properties with the micro-structural formation to integrate a three-dimensional topology with the natural micro-structure of the porous material. Such integrated structures can be formed from monoliths of porous media by machining, by molding, or by compressing or sintering micro-powders into a mold to create the desired micro-structured, micro-porous shape.

Nano-structured materials are porous materials with features sizes measured on the order of nano-meters or Angstroms. Nano-structured materials are formed in a similar manner to the micro-structured materials.

Creation of complex microstructures using micro-structured materials presents challenges for the creation of composite structures. Composite structures can be formed by the deposition of one or more metals onto or into a microstructure to render the surfaces of the microstructure catalytically active. The deposition of conductive materials onto a microstructure renders the structure conductive. Graded porosity is created by selectively filling micro-pores with a barrier material or the deposition of micro-particles of micro-porous materials onto some macro-porous carrier.

In all these applications, the deposition of nano-particles and nano-crystals onto a microstructure is difficult using conventional particle deposition techniques. Electro-phoretic deposition and electroplating cannot work with nano-sized particles, physical vapour deposition techniques can coat the visible surfaces only, with a uniform film, and do not provide the opportunity for mixing multiple materials on the micro-structured surface. Furthermore, vapour deposition methods cannot penetrate deeply enough into a structures micro-features.

The method of depositing nano-particles and nano-crystals directly onto and into microstructures uses high concentration nano-particle dispersions. These dispersions have been formulated to provide very stable high concentration dispersions of nano-particles or nano-crystals in a carrier liquid having very low overall viscosity. The colloidal dispersion is then easily deposited on a microstructure whereupon the capillary interaction of the microstructure and the colloidal dispersion pulls the liquid into the structure. The suspended nano-particles then interact with the microstructure and are pulled out of the dispersion. Heat treating or otherwise post-treating the deposited particles strengthens the adhesion of the particles to the substrate.

The very small feature sizes of the micro-structured material, whether they are porous or non-porous makes them behave like capillaries. Before providing an example of the method, we will explain the theory of capillary action.

The spontaneous flow of a liquid through a capillary is normally described in terms of the Washburn equation:

$$\frac{{h}^{2}}{t} = \frac{r {γ}_{L V} cos Θ}{2 η}$$

where t is the time needed for a liquid to reach the penetration height/depth of h, r is the capillary radius, γ_{LV} the liquid surface tension, η is the liquid viscosity, and Θ is the three-phase contact angle between the liquid, its saturated vapor and capillary wall.

All porous materials are conveniently treated as consisting of bundles of capillaries that can be characterized by some effective radius r_{eff} given by the following equation:

$${r}_{eff} = \frac{2 ( 1 - φ )}{φ {ρ}_{s} A}$$

where φ is the volume fraction of solid in the porous material, ρₛ is the density of solid, and A is the specific surface area per gram of solid.

As the Washburn equation indicates, the penetration rate reaches a maximum value when the liquid completely wets the capillary walls (Θ=0). In the case of hydrophobic solids, such as porous carbons, characterized by large water contact angles (Θ≈90 deg), penetration rates are extremely low but this effect can partly be compensated by using a material with a higher value of reff, i.e. a material with a small internal specific surface area A. Such capillary size effects were clearly observed in studies using materials with varying porosity. While the deposition of platinum nano-particles from aqueous dispersions was almost impossible in highly porous and hydrophobic substrates, the same type of substrate with a lower porosity could easily be saturated with aqueous platinum nano-dispersions.

Highly hydrophobic solids are easily wetted (Θ=0) by organic solvents with low surface tensions γ_{LV}, such as the solvent methanol. Therefore, the penetration rates of highly porous and strongly hydrophobic substrates can significantly be increased using water/methanol mixtures. Platinum catalyst particles are dispersed in a polymer solution. The polymer is absorbed onto the internal surfaces of the hydrophobic substrate during deposition rendering these surfaces strongly hydrophilic (Θ=0), thus dramatically increasing the penetration rates. This allows the catalyst to be deposited uniformly within a certain volume of the substrate.

Example. In fuel cells, an electrochemical cell is formed by the association of an electrolyte with catalyzed electrodes. Typically, these electrodes are formed by the deposition of supported catalysts onto a porous gas diffusion electrode. Typical pore sizes are larger than 2 microns, with catalyst supported on themicro-porous materials in particles several microns in diameter.

Fuel cells can support the use of micro-structured gas diffusion media directly, but the use of the supported catalyst is problematic in such cases as the size of the supported catalyst particles is too large compared to the feature size of the microstructure.

The invention produces an electrochemical cell with a curable liquid electrolyte. The method begins by mixing a protonic polymer solution having a solvent with a monomer and a cross linking agent having at least two vinyl functionalities forming a mixture. The solvent of the protonic polymer solution is removed by distillation to obtain a curable protonic polymer electrolyte. The curable protonic polymer electrolyte is disposed on a substrate forming an intermediate.

The method then ends by treating the intermediate to cure the curable protonic polymer electrolyte into a cured electrolyte with increased viscosity and increased structural strength. The curable protonic polymer electrolyte can also be treated into a gel, a solid, a liquid with a higher viscosity than the mixture, or combinations thereof.

The invention contemplates that the method further includes the step of adding an initiator to the mixture and treating the intermediate with a procedure, such as photo-curing, thermal curing and combinations thereof.

The preferred method for treating the intermediate is by electron bombardment. The electrochemical cell is then constructed by disposing a catalyst, such as a noble metal, a transition metal, an alloy of noble metals, an alloy of transition metals, or combinations therein, on a substrate.

The substrate in the method is a mold for forming a shape, a porous media, an electrode, a catalyst support, laminates thereof, and composite structures of plastics, graphics, ceramics, glass, silicon, structural metals or combinations thereof. If porous media is used, the porous media is a foam, an aero gel, a mat, felt, paper, mesh, laminates thereof, composites thereof or combinations thereof.

The electrochemical cell of fuel cell can be formed by disposing a catalyst on the substrate prior to disposing the curable protonic polymer electrolyte on the substrate. At least a portion of the curable protonic polymer electrolyte may be removably disposed on the substrate.

The method can also include the step of adding a solvent to the mixture or adding an elastising agent to the mixture for the elctrolyte. An example of an elasticizing agent is a polymerizable vinyl monomer to enhance the toughness of structure of the cured protonic polymer electrolyte.

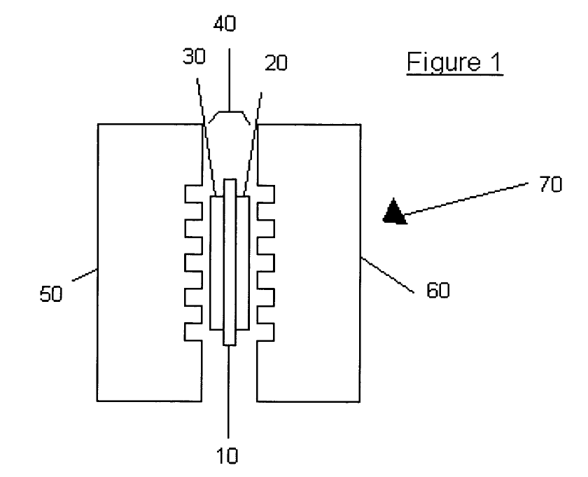

Now and with reference to the Figures, FIG. 1 schematically shows an example of an electrochemical cell incorporating a membrane of the proton exchange membrane of the invention.

FIG. 1 shows a cross section of a conventional electrochemical cell in which a solid polymer electrolyte sheet (10) is bonded to a pair of catalyzed gas diffusion electrodes (20 and 30). The assembly that results is known as a membrane electrode assembly (MEA) (40). The MEA (40) is then clamped between flow plates (50 and 60) to form a working electrochemical cell (70), in this case a fuel cell. In this example, pre-formed electrolyte sheets (10) interface between the electrolyte (10) and the electrodes (20 and 30) and rely on the mechanical bonding of the discrete components. Variations in the approach to manufacturing cells this way are used, but most continue to rely upon the mechanical bonding of the discrete MEA components. The present invention does not uses ionic boding, rather than mechanical bonding,

The electrolyte sheet (10) can be formed using the present invention by casting the electrolyte and assembling a cell. In a preferred embodiment, electrolyte sheet (10) can be formed directly on either electrode (20 or 30), thereby forming a more intimate contact between the electrolyte and one of the electrode surfaces, which is advantageous in reducing contact resistance and improving the catalyst-electrolyte-conductive media interface.

In another preferred embodiment, the electrolyte sheet (10) can be formed by applying curable liquid electrolyte according to the present invention between two electrodes (20 and 30) and then curing the resulting assembly. Curing can be by thermal, photo or electron beam methods depending upon the cross-linking initiator used in the mixture. By assembling the membrane electrode assembly in this manner, the improved electrode-catalyst interface is obtained for both electrolyte—electrode interfaces. In addition, the formation of the membrane electrode assembly in this manner does not require high temperatures or high pressures to be employed, allowing for flexibility in the selection of materials for porous electrodes (20 and 30) and lower manufacturing costs

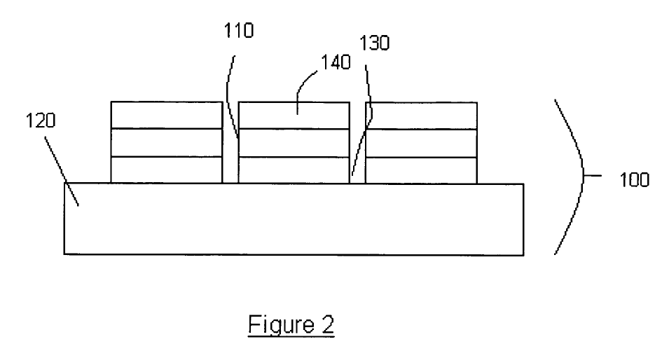

FIG. 2 shows a cross sectional view of a micro fuel cell (100) in which curable electrolyte layers are applied by spin-coating the electrolyte (110) onto a planar substrate (120) containing multiple anode regions (130). As with the previous example, the uncured electrolyte can be used as the basis for assembly of cathodes (140) onto the individual fuel cells. Due to the properties of the curable liquid electrolyte the dimensions of the spin-coated electrolyte layer will not alter significantly during curing.

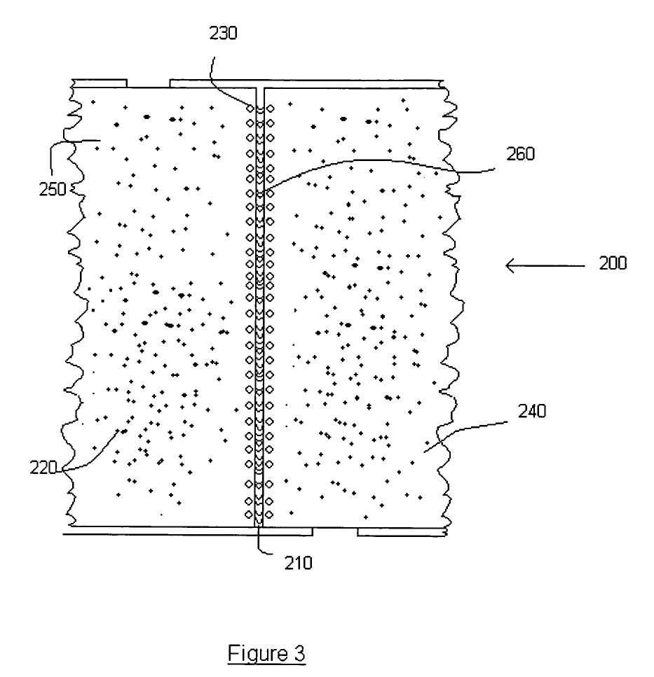

FIG. 3 shows the cross-sectional view of yet a different fuel cell topology in which a fuel cell (200) is created by forming a channel (210) within a porous substrate (220). Catalyst (230) is added to create anode (240) and cathode (250) regions. Finally, the electrolyte (260) is injected into the channel and then cured to form the electrolyte layer in-situ within the fuel cell. It would be difficult to assemble this fuel cell without a form of curable liquid electrolyte. Solvent based liquid polymer electrolyte formulations contain very low percentage of electrolyte and would shrink significantly as the solvent is driven off in order for the electrolyte to solidify.

This example discloses the preparation of liquid electrolyte using sulfonated PEEK as an example of an ionic polymer. Sulfonated PEEK was prepared by direct sulfonation reaction of PEEK with concentrated sulfuric acid (95-98%). An amount of PEEK (18 grams) was first dissolved in 300 ml sulfuric acid at room temperature. The reaction was carried out overnight at room temperature, followed by heating for 3 hours to 8 hours on a 55 degrees Celsius oil bath to control the sulfonation level of resultant polymers.

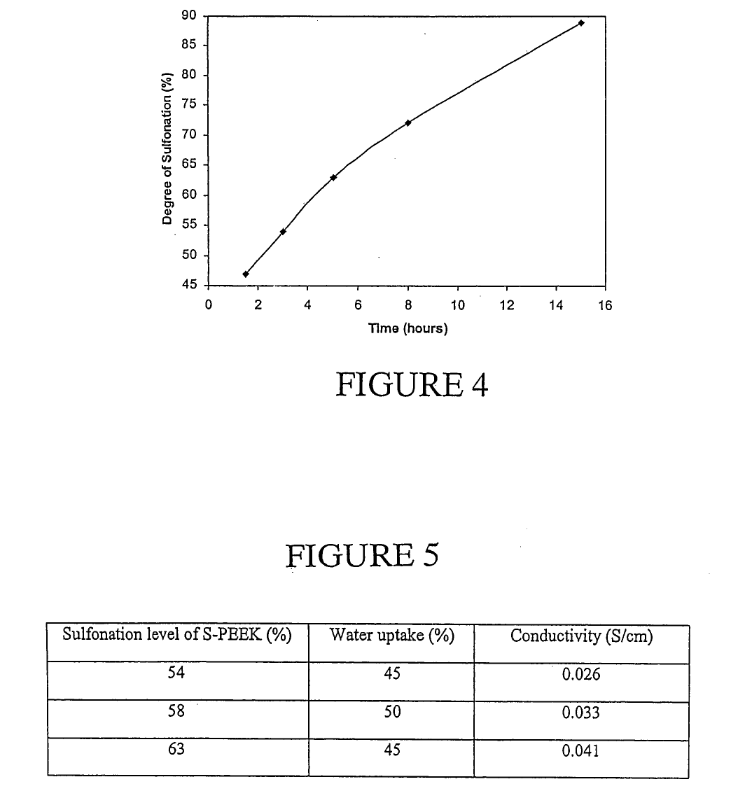

FIG. 4 shows the time dependence of sulfonation levels at 55 degrees Celsius. The ability to control sulfonation is important for control of eventual electrolyte performance characteristics.

Liquid electrolyte was prepared by dissolution of S-PEEK in a vinyl monomer mixture in the absence or presence of a photo-initiator or a photo-initiating system. Generally, vinyl monomers mixtures consist of a protonic monomer, vinyl phosphoric acid, cross-linking agent divinyl sulfone, and a third monomer acrylonitrile. In some cases, water and or an organic compound, N,N-dimethylacetamide, (DMA) can be added. The liquid electrolyte was cured by photo or electro beam (EB) exposure.

A second example of a photo-curable liquid electrolyte uses 30% wt/wt S-PEEK (71% sulfonation) and 70% monomer mixture (22.5% vinyl phosphoric acid, 52.5% divinyl sulfone, and 25% acrylonitrile of the mixture) in the presence of 3.75% photo-initiator of monomers was formed with good mechanical properties and good proton conductivity usable for a fuel cell or other electrochemical cell.

This electrolyte used S-PEEK (865 mg) dissolved in 2000 mg monomer mixture composing of vinyl phosphoric acid (450 mg), divinyl sulfone (1050 mg), and acrylonitrile (500 mg) in the presence of a photo initiator (75 mg). An electrolyte membrane was prepared by casting the resultant liquid electrolyte on a glass slide and exposing the film to visible light for four hours. The membrane was freed from the slide by soaking with water. Proton conductivity was 0.058 S/cm at room temperature and 100% humidity. The conductivity measurement was made with an impedance analyzer.

An electron beam curable liquid electrolyte composed of 30% wt/wt S-PEEK (58% sulfonation) and 70% monomer mixture (15% vinyl phosphoric acid, 55% divinyl sulfone, and 30% methylacrylonitrile of the mixture) in the presence of 12.2% of N, N-dimethylacetamide was made.

Another example of a curable electrolyte is S-PEEK (865 mg) dissolved in 2000 mg monomer mixture comprised of vinyl phosphoric acid (300 mg), divinyl sulfone (100 mg), and methylacrylonitrile (600 mg). An electrolyte membrane from this mixture was prepared by casting the resultant liquid electrolyte on a glass slide forming a film and exposing the electrolyte to a electron beam with a dose of about 250 KGy. The proton conductivity of the membrane is 0.060 S/cm at room temperature with 100% humidity.

In a preferred cell, small voids can be formed directly within the liquid electrolyte that acts as a water reservoir to aid in humidification of the cured membrane. These voids are formed by including a high boiling point organic compound within the liquid electrolyte mixture. A liquid electrolyte composing 30% wt/wt S-PEEK (63% sulfonation) and 70% monomer mixture (15 vinyl phosphoric acid, 45% divinyl sulfone, and 30% acrylonitrile of the mixture) in the presence of 20% of N,N-dimethylacetamide was usable.

In still another example, S-PEEK (865 mg) was dissolved in 2000 mg monomer mixture composing of vinyl phosphoric acid (300 mg), divinyl sulfone (900 mg), and acrylonitrile (800 mg) in the presence of a photoinitiator (75 mg) and N,N-dimethylacetamide (567 mg). An electrolyte membrane was prepared by casting the resulting liquid electrolyte on a glass slide and exposing the film to visible light for 4 hours. Nano-voids were created by removal of N,N-dimethylacetamide under vacuum at room temperature.

In another version of this example, the temperature could be elevated to drive off the N,N-dimethylacetamide. The proton conductivity of the resultant membrane was found to be 0.039 S/cm at room temperature with 100% humidity.

In still another embodiment, water is included within the liquid mixture described above so that after curing a pre-hydrated membrane is formed. The pre-hydrated membrane preferable made from a liquid electrolyte composed of S-PEEK (71% sulfonation) and a monomer mixture (22.5% vinyl phosphoric acid, 52.5% divinyl sulfone, and 25% acrylonitrile of the mixture) in the presence of water. For this example, S-PEEK (865 mg) was dissolved in 2000 mg monomer mixture composed of vinyl phosphoric acid (450 mg), divinyl sulfone (1050 mg), and acrylonitrile (500 mg) in the presence of a photoinitiator (75 mg) and water (600 mg). An electrolyte membrane was prepared by casting the resultant liquid electrolyte on a glass slide forming a film and exposing the film to visible light for three hours. The proton conductivity of the membrane was measured at 0.060 S/cm at room temperature with 100% humidity.

FIG. 5 shows a table of performance data indicating that the conductivity of the cured electrolyte can be controlled by controlling the sulfonation level of the SPEEK as previously described. The figure provides measured results for 3 liquid electrolytes composing 30% wt S-PEEK with different sulfonation levels and 70% monomer mixture (15 vinyl phosphoric acid, 42.5% divinyl sulfone, and 42.5% acrylonitrile) in the presence of 2.6% photoinitiator and 20% of N,N-dimethylacetamide.

For these examples, S-PEEK (865 mg) was dissolved in 2000 mg monomer mixture composed of vinyl phosphoric acid (300 mg), divinyl sulfone (850 mg), and acrylonitrile (850 mg) in the presence of a photo initiator (75 mg) and N,N-dimethylacetamide (567 mg). Electrolyte membranes were prepared by casting the resultant liquid electrolytes on glass slides forming a film and exposing the films to visible light for four hours. The proton conductivity of those membranes at room temperature with 100% humidity is shown in FIG. 5.

The conductivity and the amount of water uptake of the electrolyte can be controlled by controlling the degree of cross-linking when the curable liquid electrolyte is cured. A liquid electrolyte which has the composition of 30% S-PEEK (63% sulfonation) and 70% monomer mixture (30:62.5:22.5 ratio of vinyl phosphoric acid, divinyl sulfone, and acrylonitrile) can be usable. This electrolyte forms S-PEEK (865 mg) dissolved in a monomer mixture (200 mg) composing of vinyl phosphoric acid (300 mg), divinyl sulfone (850 mg), and acrylonitrile (850 mg) in the presence of a photo initiator (75 mg) and N,N-dimethylacetamide (567 mg). Electrolyte membranes were prepared by casting the resultant liquid electrolyte on glass slides forming a film and exposing them to visible light for four hours. The resultant membrane showed high mechanical strength and high stability in water due to the high degree of cross-linking resulting from the large amount of divinyl sulfone used in the mixture.

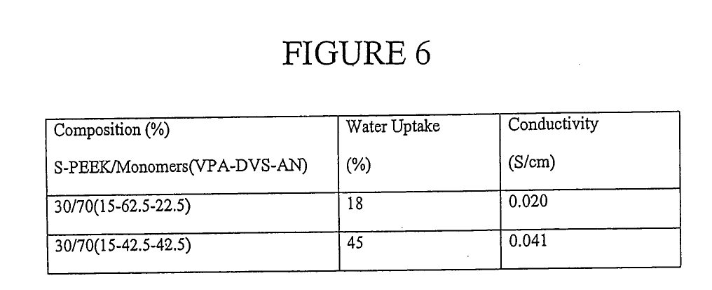

FIG. 6 demonstrates the room temperature proton conductivity and water uptake of this membrane and another membrane prepared from a similar liquid electrolyte using a lower content of divinyl sulfone.

Conductivity and water uptake are also controllable by controlling the degree of polymerization. A liquid electrolyte composing of 70% S-PEEK (58% sulfonation) and 70% monomer mixture (30:62.5:22.5 ratio of vinyl phosphoric acid, divinyl sulfone, and acrylonitrile) with 14% of N,N-dimethylacetamide was cured by electron beam with different doses to control the degree of polymerization of monomers.

For this version. S-PEEK (865 mg) was dissolved in a monomer mixture (200 mg) composing of vinyl phosphoric acid (300 mg), divinyl sulfone (1300 g), and acrylonitrile (400 mg) in the presence of N,N-dimethylacetamide (400 mg). Electrolyte membranes were prepared by casting the resultant liquid electrolyte on a glass slide forming a film and exposing to an electron beam with doses varying form 150 KGy to 350 KGy.

The examples of curable liquid electrolytes given so far have been based on S-PEEK. In another embodiment, curable liquid electrolytes are formed based on the use of recast Nafion™ for nano-sized fuel cells.

A curable recast Nafion™ electrolyte was prepared by exchanging the original solvents in 5% Nafion™ 117 solution with vinyl monomers. Nafion™ solution was added to a vinyl monomer mixture in the absence or presence of a photo initiator or a photo initiating system. The vinyl monomer mixture consisted of a protonic monomer, a vinyl phosphoric acid, a cross-linking agent, and a divinyl sulfone. A high boiling point organic solvent, N,N-dimethylacetamide, (DMA) may be added for enhanced annealing of the cured electrolytes. The original solvents of the Nafion™ solution were removed by soft vacuum distillation using a rotary evaporator to give a photo-curable or electron-beam-curable liquid electrolyte. Cured electrolytes were annealed between 140 degrees Celsius and 160 degrees Celsius to improve their mechanical strength and solvent resistance.

In another embodiment, a photo-curable recast Nafion™ electrolyte composed of 30% Nafion 117 and 70% monomer mixture (15:65:20 ratio of vinyl phosphoric acid, divinyl sulfone, and acrylonitril) was prepared. The 5% Nafion™ 117 solution was mixed with a monomer mixture of vinyl phosphoric acid (300 mg) and divinyl sulfone (1300 mg) in the presence of a photoinitiator (75 mg) and N,N-dimethylacetamide (500 mg). After the removal of the original solvent, acrylonitrile (400 mg) was added. A membrane was prepared by casting a liquid layer on a glass slide forming a film and curing with a visible light for four hours. The membrane was annealed on the glass slide between 140 degrees Celsius and 150 degrees Celsius for 4 hours in a nitrogen atmosphere. A strong and flexible recast Nafion™ membrane was freed from the glass by soaking with deionized water. This membrane shows excellent stability in boiling water with a water uptake of 31% at room temperature.

In an alternate embodiment, an electron-beam curable recast Nafion™ electrolyte was formed composed of 30% Nafion™ 117 and 70% monomer mixture (15:55:30 ratio of vinyl phosphoric acid, divinyl sulfone, and methylacrylonitrile) in the presence of N,N-dimethylacetamide. The 5% Nafion™ 117 solution was mixed with a monomer mixture of vinyl phosphoric acid (300 mg) and divinyl sulfone (1100 mg) in the presence of N,N-dimethylacetamide (500 mg), After the removal of the original solvents, methylacrylonitrile (600 mg) was added. A membrane was prepared by casting a liquid layer of the electrolyte on a glass slide and curing with electron beam (EB) at doses of about 100 KGy. The membrane was annealed on the glass slide between 140 degrees Celsius and 150 degrees Celsius for four hours in a nitrogen atmosphere. The proton conductivity of the cured membrane is 0.031 at room temperature.

The conductivity of the recast Nation liquid electrolytes can be controlled by controlling the degree of cross-linking. A curable recast Nafion™ electron composed of 30% Nafion™ 117 and 70% monomer mixture (15:42.5:42.5 ratio of vinyl phosphoric acid, divinyl sulfone, and acrylonitrile) was prepared with a lower degree of cross-linking than the original recast Nafion™ example. Nafion™ 117 solution was mixed with a monomer mixture of vinyl phosphoric acid (300 mg) and divinyl sulfone (850 mg) in the presence of a photo initiator (75 mg) and N,N-dimethylacetamide (500 mg). After the removal of the original solvents, a third monomer, acrylonitrile (850 mg) was added. A membrane was prepared by casting a liquid layer on a glass slide and curing with visible light for four hours. The membrane was annealed on the glass slide between 140 degrees Celsius and 150 degrees Celsius for four hours in a nitrogen atmosphere.

While this invention has been described with emphasis on the preferred embodiments, it should be understood that within the scope of the appended claims, the invention might be practiced other than as specifically described herein.

What is claimed is:

1. An electrochemical cell comprising a curable protonic polymer based electrolyte composition, wherein the electrolyte composition comprises:
a. between 10 wt % and 50 wt % of the protonic polymer comprising acidic groups for transporting protons;
b. between 10 wt % and 89 wt % of a monomer for dissolving the protonic polymer;
c. between 1 wt % and 60 wt % of a cross linking agent having at least two vinyl functionalities; and
d. wherein upon combining the protonic polymer, monomer and cross linking agent, a curable electrolyte solution is formed with at least 50 wt % of the above components based on the total weight percent of the formed solution.

2. The electrochemical cell of claim 1, further comprising a quantity of initiator sufficient to cure the composition when using a procedure comprising of photo-curing, thermal curing and combinations thereof.

3. The electrochemical cell of claim 1, wherein the protonic polymer comprises acid groups.

4. The electrochemical cell of claim 1, wherein the monomer is a vinyl monomer bearing an acidic group.

5. The electrochemical cell of claim 4, wherein the acidic group comprises a sulfonic acid group, a phosphonic acid group, a carboxylic acid group, and combinations thereof.

6. The electrochemical cell of claim 1, wherein the cross-linking agent vinyl functionalities are divinyl derivatives of an organic compound.

7. The electrochemical cell of claim 6, wherein the organic compound is selected from the group consisting of an aliphatic, an aromatic, a heteroaromatic and combinations thereof.

8. The electrochemical cell of claim 6, wherein the organic compound is selected from the group consisting of sulfonic acid, sulfones, phosphates, phosphones, phosphonic acid, carboxylates, carboxylic acid, acrylates, methylacrylates, acrylamides, methacrylamides, and combinations thereof.

9. The electrochemical cell of claim 1, wherein the cross linking agent vinyl functionality is a trivinyl derivative of an organic compound.

10. The electrochemical cell of claim 9, wherein the organic compound is selected from the group consisting of sulfonic acid, sulfones, phosphates, phosphones, phosphonic acid, carboxylates, carboxylic acid, acrylates, methylacrylates, acrylamides, methacrylamides, and combinations thereof.

11. The electrochemical cell of claim 1, wherein the curable liquid electrolyte solution further comprises an elastising agent.

12. The electrochemical cell of claim 1, wherein the elasticizing agent is a polymerizable vinyl monomer to enhance the toughness of structure of the cured electrolyte.

13. The electrochemical cell of claim 1, consisting of:
a. between 20 wt % and 40 wt % of a protonic polymer comprising acidic groups for transporting protons;
b. between 20 wt % and 70 wt % of a monomer for dissolving the protonic polymer; and
c. between 5 wt % and 50 wt % of a cross linking agent having at least two vinyl functionalities.

14. A fuel cell with a curable electrolyte, wherein the curable electrolyte comprises:
a. between 10 wt % and 50 wt % of a protonic polymer comprising acidic groups for transporting protons;
b. between 10 wt % and 89 wt % of a polar monomer;
c. a polar solvent for dissolving the polar monomer;
d. between 1 wt % and 60 wt % of a cross linking agent having at least two vinyl functionalities; and
e. wherein upon wherein upon combining the protonic polymer, polar vinyl monomer, polar solvent, and cross linking agent, a curable electrolyte solution is formed with at least 50 wt % of the above components based on the total weight percent of the formed solution.

15. The fuel cell of claim 14, wherein the polar solvent is water.

16. The fuel cell of claim 14, wherein the polar solvent is organic.

17. The fuel cell of claim 14, wherein the polar solvent comprises dimethylformamide, dimethylacetamide, n-methylpyrrolidinone and combinations thereof.

18. The fuel cell of claim 14, wherein the polar monomer is a vinyl monomer bearing an acidic group.

19. The fuel cell of claim 18, wherein the acidic group comprises a sulfonic acid group, a phosphonic acid group, a carboxylic acid group and combinations thereof.

20. The fuel cell of claim 14, wherein the cross linking agent is a divinyl derivative of an organic compound.

21. The fuel cell of claim 20, wherein the organic compound comprises an aliphatic, an aromatic, a heteroaromatic, and combinations thereof.

22. The fuel cell of claim 20, wherein the organic compound comprises a sulfonic acid, a sulfone, a phosphate, a phosphone, a phosphonic acid, a carboxylate, a carboxylic acid, an acrylate, a methylacrylate, an acrylamide, a methacrylamide, and combinations thereof.

23. The fuel cell of claim 14, wherein the cross linking agent is a trivinyl derivative of an organic compound.

24. The fuel cell of claim 23, wherein the organic compound comprises sulfonic acid, phosphates, phonsphonic acid, carboxylates, carboxylic acid, acrylates, methylacrylates, acrylamides, methacrylamides, and combinations thereof.

25. The fuel cell of claim 14, wherein the protonic polymer comprises sulfonic acid, carboxylic acid, and combinations thereof.

26. The fuel cell of claim 14, further comprising an elasticizing agent.

27. The fuel cell of claim 26, wherein the elasticizing agent is a polymerizable vinyl monomer to enhance the toughness of structure of the cured electrolyte.

28. The fuel cell of claim 14, further comprising an initiator usable when the electrolyte is cured by photo-curing, thermal curing, and combinations of thereof.

29. A method for producing a curable liquid electrolyte for an electrochemical cell comprising the steps of:
a. mixing a protonic polymer solution with a solvent comprising a monomer and a cross linking agent forming a mixture, wherein the cross linking comprises at least two vinyl functionalities;
b. removing the solvent from the mixture by distillation to obtain a curable protonic polymer electrolyte;
c. disposing the curable protonic polymer electrolyte on a substrate forming an intermediate; and
d. treating the intermediate to form a cured electrolyte with increased viscosity and increased structural strength.

30. The method of claim 29, further comprising the step of adding an initiator to the mixture and treating the intermediate with a procedure selected from the group consisting of photo-curing, thermal curing and combinations thereof.

31. The method of claim 29, wherein the treating of the intermediate is by electron bombardment.

32. The method of claim 29, further comprising the step of adding a solvent to the mixture.

33. The method of claim 29, further comprising the step of adding an elastising agent to the mixture.

34. The method of claim 33, wherein the elasticizing agent is a polymerizable vinyl monomer to enhance the toughness of structure of the cured protonic polymer electrolyte.
